(19) United States
(12) Patent Application Publication
(10) Pub. No.: US 2018/0244128 A1
(43) Pub. Date: Aug. 30, 2018

(54) VENTILATION SYSTEM

(71) Applicant: Jaguar land Rover Limited, Coventry, Warwickshire (GB)

(72) Inventor: Neil BELOE, Whitley, Coventry (GB)

(21) Appl. No.: 15/757,499

(22) PCT Filed: Sep. 14, 2016
(86) PCT No.: PCT/EP2016/071667

§ 371 Date: Mar. 5, 2018

(30) Foreign Application Priority Data
Sep. 17, 2015 (GB) 1516460.1

(51) Int. Cl. B60H 1/00; B60H 1/24

(52) U.S. Cl. CPC B60H 1/00564; B60H 1/008; B60H 1/248; B60H 1/00321; B60H 1/00785

(57) ABSTRACT

The present invention relates to a ventilation system 24 for a land vehicle 10. The ventilation system 24 comprises an inlet duct 26 for allowing exterior air to enter a cabin of the vehicle. The inlet duct 26 has a source port 38 located at an exterior of the vehicle 10 and the inlet duct 26 also has an exhaust port 40 located within a cabin of the vehicle 10. The ventilation system 24 has an outlet duct 28 for allowing interior air to exit the cabin of the vehicle 10. The outlet duct 28 has a source port 44 located within the cabin of the vehicle 10 and the outlet duct 28 also has an exhaust port 46 located at an exterior of the vehicle. The ventilation system 24 has an air propulsion element to cause selectively an airflow between the cabin interior and the vehicle exterior; wherein the source port 38 of the inlet duct 26 and the exhaust port 46 of the outlet duct 28 are collocated in a zone of substantially equivalent dynamic pressure, in-use.

### TECHNICAL FIELD

The present disclosure relates to a ventilation system for a vehicle, particularly but not exclusively a land vehicle. Aspects of the invention relate to a ventilation system, a land vehicle, and a method of ventilating a vehicle.

### BACKGROUND

A land vehicle, such as a car or other like, has an outer shell including a body and various doors and windows. The shell divides a vehicle exterior from a cabin interior. When the windows and doors are shut, the shell hermetically seals the cabin interior from the vehicle exterior. In order to provide an air flow through the car, the car includes a ventilation system.

A typical ventilation system includes an inlet duct and an outlet duct. In order to promote air flow through the duct to ventilate the car, a source port of the inlet duct is located in a high pressure region of the vehicle exterior and an exhaust port of the outlet duct is located in a low pressure region of the vehicle exterior.

When a car is stationary the static pressure is substantially constant around the exterior of the vehicle. During motion of the vehicle, the vehicle exterior is divided in to a plurality of zones where each zone exhibits a different dynamic pressure to the other zones. The dynamic pressure changes during motion of the vehicle due to various air flows around the vehicle. For instance, areas of high velocity air flow exhibit a reduction in dynamic pressure compared to areas experiencing lower velocity air flow. These changes in velocity are aerodynamic effects indicative of the shape and contours around the exterior surface of the vehicle. In addition, factors such as ram-air can be experienced by any ports or ducts at the front end of the vehicle facing oncoming airflows. This ram-air increases the pressure within the affected duct.

In order to induce air flow through the ventilation system, the source port of the inlet duct is located at a pressure zone defined at a front end of the vehicle and the exhaust port of the outlet duct is located at a rear end of the vehicle. In this way, the respective source and exhaust ports of the inlet and outlet ducts are located in different dynamic pressure zones around the exterior of the vehicle. In particular, the source port of the inlet duct is located in a high dynamic pressure region whereas the exhaust port of the outlet duct is located in a low pressure zone.

Arranging the ventilation system in this way is thermally inefficient since any cooling or heating of the air within the cabin interior will escape to the exterior environment of the vehicle as a result of the ventilated air flow through the inlet and outlet ducts.

It is an object of the present invention to improve on the prior art.

### SUMMARY OF THE INVENTION

According to an aspect of the present invention there is provided a ventilation system for a land vehicle, the ventilation system comprising; an inlet duct for allowing exterior air to enter a cabin of the vehicle, the inlet duct having a source port located at an exterior of the vehicle and the inlet duct also having an exhaust port located within the cabin of the vehicle; an outlet duct for allowing interior air to exit the cabin of the vehicle, the outlet duct having a source port located within the cabin of the vehicle and the outlet duct also having an exhaust port located at an exterior of the vehicle; and an air propulsion element arranged to cause selectively an airflow between the cabin interior and the vehicle exterior; wherein the source port of the inlet duct and the exhaust port of the outlet duct are collocated in a zone of substantially equivalent dynamic pressure, in-use.

By substantially equivalent dynamic pressure zone, is intended a region of the exterior of the vehicle which does not exhibit a pressure difference during motion of the vehicle. Locating the source port of the inlet duct and the exhaust port of the outlet duct in a zone of substantially equivalent dynamic pressure means that no continuous air flow exists through the ventilation system, as a result of the motion of the vehicle. Minimising unintended air flow through the ventilation system results in a more thermally efficient vehicle since any heating or cooling performed at the cabin interior does not escape inadvertently through the ventilation system. In addition, selectively operating the air propulsion element only when an air flow is required results in a system which consumes less power.

The inlet duct and the outlet duct may share a common structural interface to divide the inlet duct from the outlet duct.

The common structural interface to divide the respective ducts provides for an even more thermally efficient system since any thermal energy in the cold or hot air exiting the cabin interior will be conducted to the air entering from the vehicle exterior. Consequently, other vehicle systems, such as an air conditioning system or a heating system, will not have to perform at such a high level since the air entering the cabin will acquire thermal energy that is recovered from the air exiting the cabin.

The common structural interface may comprise a heat exchange feature.

The heat exchange feature may comprise a formation selected from a list comprising any one or more: fins, ribs, pins, dimples and/or grooves.

The surface features increase the surface area of the common structural interface in order to improve the transfer of thermal energy from one air flow to the other. By effectively disrupting the flow of the boundary layer of air that is in contact with the common structural interface, the surface features passively promote the mixing of air within the inlet and outlet duct and thus promote the transfer of heat energy across the common structural interface.

The inlet duct and the outlet duct may be concentrically arranged pipes.

By concentrically arranging the pipes, the common structural boundary between the inlet and outlet ducts is provided by one of the pipes of the inlet or outlet ducts. Arranging the ducts in this way means that the structure of the inner pipe is the common structural interface dividing the two ducts. Such an arrangement maximises the contact area between the ducts leading to increased conduction and thus even further thermal efficiencies.

The inlet duct and the outlet duct may be formed as eccentrically arranged pipes. Arranging the pipes in this way provides many of the benefits afforded by the concentric arrangement. In addition, the off-centre pipes increase the amount of flow disturbance of the air flowing through the ventilation system.

The outlet duct may form an interior pipe and the inlet duct may form an exterior pipe.

The outlet duct forming the interior pipe means that the structure of the outlet duct forms the common structural interface. This is more efficient than having the inlet duct as the common interface since any energy in the air flowing out of the cabin is used to conduct to the in flowing air as opposed to escaping to the exterior environment as would be the case if the outlet duct was arranged as an outermost pipe.

The air propulsion element may comprise a variable speed fan.

The air propulsion element comprising a fan is a relatively simple and low cost way in which to propel the air. In addition, the variable speed nature of the fan is an easy way in which to control the flow of air through the ventilation system.

The inlet and outlet ducts may be continuous, door-less, ducts arranged aside from the air propulsion element.

Continuous door-less ducts are not known from the prior art since existing ventilation systems usually comprise doors to switch the air flow between inlet and outlet ducts. Due to the positioning of ventilation ducts within existing ventilation systems, the motion of the vehicle forces air into the vehicle cabin. Duct doors are therefore required to control the flow of air entering the cabin. Providing a continuous, door-less system means that there are no transient spikes in pressure change when operating such doors. Minimising the risk of transient pressure spikes improves passenger comfort. Due to the lack of ventilation doors, the resistance to the flow of air within a continuous door-less duct is reduced, which reduces the power required by the fan to propel the air within the duct.

The ventilation system may comprise an interior environment parameter sensor arranged to monitor an environment parameter within the cabin interior.

By environment parameter is intended any parameter of the air within the cabin interior.

The ventilation system may comprise a control module arranged to configure the air propulsion element to induce a flow of air between the vehicle exterior and the cabin interior based upon the level of the environment parameter measured within the cabin, the flow of air is arranged to maintain a level of the environment parameter within the cabin to within a predefined limit.

Controlling the environment parameter within the cabin to within a predefined limit improves passenger comfort. By only altering the flow of air between the vehicle exterior and the cabin interior in order to maintain the environment parameter level within the predefined limit, the air propulsion element is only operated when needed. Therefore, much of the power consumed by conventional ventilation systems is not needed, and can be utilised to power other vehicle features. This is especially important for electric vehicles where battery power may also be used in the propulsion of the vehicle.

The ventilation system may comprise a complimentary exterior environment parameter sensor at the vehicle exterior to monitor the same environment parameter as monitored by the interior environment parameter sensor.

In this way, the same environment parameter is monitored at both the cabin interior and the vehicle exterior.

The control module may also be arranged to configure the air propulsion element to induce an air flow between the vehicle exterior and the cabin interior based upon the level of the environment parameter at the exterior of the vehicle.

Such an arrangement may be advantageous in non-typical environments such as large cities where pollution is abundant in the exterior atmosphere. Controlling the air flow through the ventilation system according to the environment parameter at both the interior and exterior of the vehicle provides for a more robust system to keep the environment parameter within the cabin to within the predefined limit.

The environment parameter may be CO₂.

CO₂ can build up within the cabin interior as a result of occupants breathing. This CO₂ would steadily increase over time in the absence of an air flow through the ventilation system.

The environment parameter may be humidity.

Humidity is another parameter of the environment which can change as a result of occupants within the cabin interior which over time can build up in the absence of an air flow through the ventilation system.

According to another aspect of the present invention there is provided a land vehicle defining a vehicle exterior having a plurality of dynamic pressure zones in-use, the vehicle comprising a cabin defining a vehicle interior, wherein the vehicle also comprises the aforementioned ventilation system.

A further aspect of the present invention provides for a method of ventilating a vehicle.

The method may comprise monitoring an environment parameter within a cabin interior of the vehicle, and inducing a flow of air between a vehicle exterior and the cabin interior based in dependence on a level of the monitored environment parameter. In one embodiment, the method comprises operating the air propulsion element of the above described ventilation system in dependence on the monitored environmental parameter.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic of a ventilation system according to an embodiment of the present invention;

FIG. 2 shows a cross sectional view of an inlet and outlet duct shown in FIG. 1; and

FIG. 3 shows a land vehicle according to an embodiment of the present invention.

### DETAILED DESCRIPTION

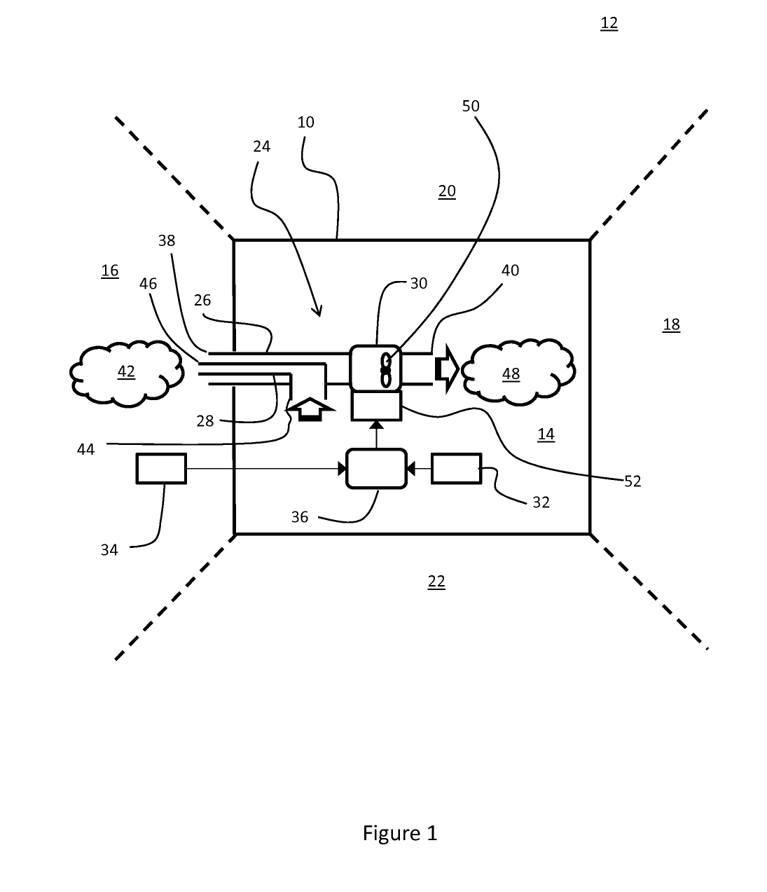

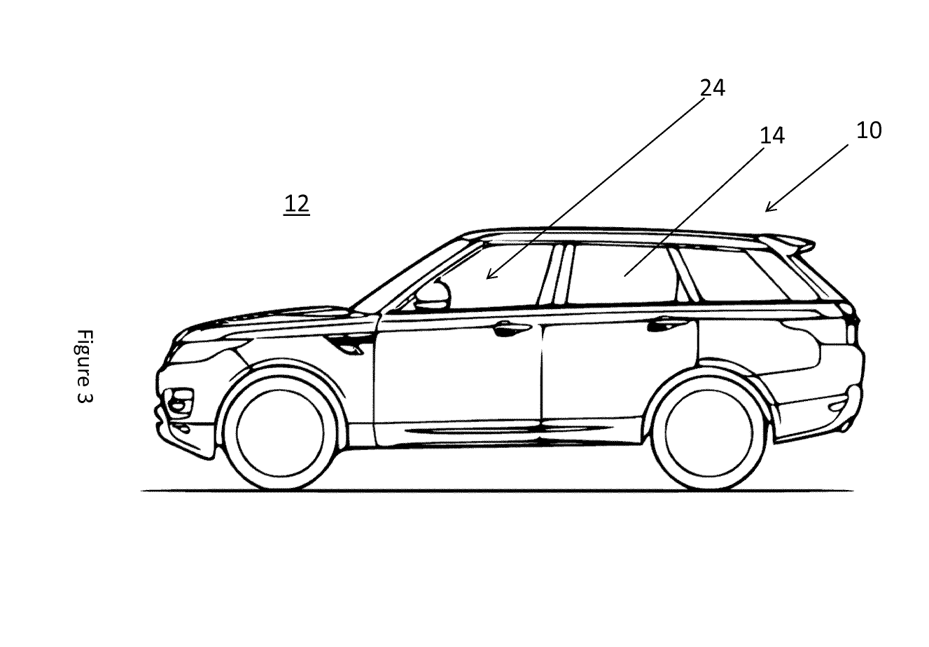

With reference to FIG. 1 and FIG. 3, a vehicle 10 includes a body supporting a plurality of doors and windows (not shown). The vehicle defines a vehicle exterior 12 and a cabin interior 14 since the body of the vehicle is substantially hermetically sealed unless the doors and/or windows are open. When the vehicle 10 is stationary, the exterior of the vehicle 12 is at a substantially constant pressure. This of course is subject to factors such as local wind speeds and temperature variations around the vehicle 10. However, to all intents and purposes the pressure around the vehicle exterior 12 is substantially constant.

During motion of the vehicle 10, pressure variations exist around an exterior surface of the vehicle 10. These changes in pressure are due to dynamic effects. For instance, local air velocities around the exterior surface of a vehicle 10 change due to differences in shape and contours thereof. An increase in local velocity can result in a decrease in local pressure. A decrease in velocity can result in an increase in local pressure. Other effects such as ram-air also have an impact on the pressure at the exterior surface of vehicle 10, again causing local changes and variations in pressure.

Broadly speaking, the vehicle can be imagined as having a plurality of dynamic pressure zones where the pressure across a particular zone is substantially constant. The pressure across the front of the vehicle 10 is substantially constant and at a higher pressure than experienced at the rear of the vehicle 10, which is also a zone of substantially constant dynamic pressure. In addition, a top side of the vehicle 10 may have substantially constant pressure thereacross, which would be at a different pressure to an underside of the vehicle 10. In this way, the vehicle exterior 12 can be imagined as having a front pressure zone 16, a rear pressure zone 18, an upper pressure zone 20, and a lower pressure zone 22. As described above, these zones 16-22 may experience different dynamic pressures to one another during motion of the vehicle.

The vehicle 10 includes a ventilation system 24. The ventilation system 24 includes an inlet duct 26, an outlet duct 28, an air propulsion element 30, an interior environment parameter sensor 32, an exterior environment parameter sensor 34, and a control module 36.

The inlet duct 26 is a pipe. The inlet duct 26 includes a source port 38, and an exhaust port 40. The source port 38 and the exhaust port 40 are formed from pipe ends. The source port 38 is located in the front pressure zone 16. The exhaust port 40 of the inlet duct 26 is located within the cabin interior 14. The inlet duct 26 allows exterior air 42 to enter the cabin interior 14.

The outlet duct 28 is formed from an elbow pipe. One elongated section of the pipe is concentrically arranged with the pipe forming the inlet duct 26. In this way, the outlet duct 28 forms an interior pipe and the in inlet duct 26 forms an exterior pipe. The pipes may be arranged in different ways such as an eccentric arrangement for flow distribution reasons, if desired. However, for the concentric arrangement, a transverse section of the elbow pipe protrudes through a passage provided at a wall of the inlet duct 26. The transverse portion of the pipe terminates at a source port 44 located within the cabin interior 14. The other section of the pipe terminates at an exhaust port 46 located in the front pressure zone 16 at the vehicle exterior 12. The source port 44 and the exhaust port 46 are formed as pipe ends.

The source port 38 of the inlet duct 26 and the exhaust port 46 of the outlet duct 28 are thus collocated in a zone of substantially equivalent dynamic pressure, namely the front dynamic pressure zone 16. These ports may be collocated at the front zone 16 as opposed to the rear zone 18 since the vehicle 10 has an engine exhaust (not shown) located at the rear of the vehicle 10. This should minimise the risk of engine pollutants entering the cabin interior 14. Alternatively, in the case of an electric vehicle the ports may be collocated at either the front 16 or rear 18 pressure zone.

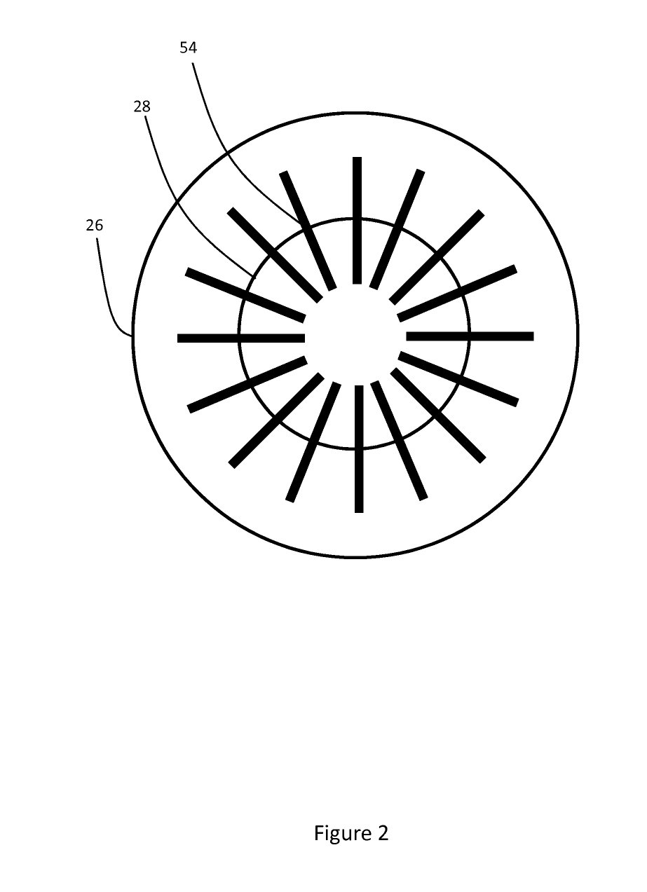

With reference to FIG. 2, a cross sectional view of the concentrically arranged inlet and outlet duct, 26 and 28 respectively, is shown. Arranged across a common structural interface, which joins the inlet and outlet duct, are one or more heat exchange features, in the form of fins 54. The fins 54 increase the surface area of the common structural interface in order to conduct a larger amount of thermal energy from one air flow to the other.

With further reference to FIG. 1, the air propulsion element 30 comprises a variable speed fan 50. The fan 50 is located within the inlet duct 26. The fan 50 is arranged to draw exterior air 42 in to the cabin interior 14. Alternatively the variable speed fan 50 may be arranged to push interior air 48 from the cabin interior 14, to the exterior of the vehicle 12; and/or be located within the outlet duct.

The fan 50 is the only obstruction within the inlet and outlet ducts 26, 28, since each duct 26, 28 is door-less. The fan 50 is driven by a motor 52. The revolutions per minute (RPM) of the motor 52 is controlled by the control module 36. A high motor speed results in a high rotational speed of the fan 50. A low motor speed results in a low rotational speed of the fan 50. Fan speed is proportional to the flow of air being induced in to the cabin interior 14 from the vehicle exterior 12.

The interior environment parameter sensor 32 is arranged to monitor an environment parameter within the cabin interior 14. The environment parameter is a parameter of the air 14. The parameters of particular interest are CO2 and humidity. The interior environment parameter sensor 32 can thus either be a CO2 sensor, a humidity sensor, or a combination of the two.

The CO₂ sensor is a non-dispersive infrared (NDIR) sensor. The NDIR sensor is a spectroscopic sensor. The spectroscopic sensor detects CO₂ in a gaseous environment, in this case the cabin interior 14, by the characteristic absorption of the gas (cabin air 48) which the NDIR sensor acts upon.

The humidity sensor is a hygrometer. The hygrometer measures moisture content of the cabin air 48 indirectly by monitoring temperature of the dew point. An alternative hygrometer can be implemented which monitors changes in electrical capacitance or resistance in order to measure humidity differences. The exterior environment parameter sensor 34 is a complementary environment parameter sensor in that it may measure the same environment parameter as the interior environment parameter sensor 32. The exterior environment parameter sensor is located at the vehicle exterior 12. It is advantageous to use the same type of sensor for measuring each respective environment parameter, for instance, the CO₂ sensors at the interior and exterior of the vehicle are both NDIR sensors.

The interior and exterior environment parameter sensors 32, 34 are both connected to the control module 36. The control module 36 is provided as electronic data stored on a memory component of a computer of the vehicle 10. The memory component is a non-volatile memory component. The computer also includes a processor arranged to execute the electronic data of the control module 36, in use. Output of the control module 36 configures the motor 52 to control the speed of the fan 50.

The control module 36 includes a look-up table, which associates sensed environment parameter levels with rotational fan speeds. In this way, a sensed environment parameter level at the cabin interior 14 may be associated to a rotational speed of the fan 50 to induce a predetermined flow of air from the cabin exterior 12 to the cabin interior 14. In this way, the control module 36 is arranged to configure the fan 50 to induce an air flow between the vehicle exterior 12 and the cabin interior 14 based upon the environment parameter measured within the cabin. In addition, the control module 36 uses the reading from the exterior parameter sensor 34 in the same way such that the rotational speed of the fan 50 is a function of the environment parameter sensed both at the vehicle interior 14 and the vehicle exterior 16.

The level of each environment parameter within the cabin interior 14 is arranged to be kept within a predefined limit, and in certain cases within predefined limits. For CO₂ these predefined limits are between about 500 ppm and about 1500 ppm CO₂. For humidity levels, the predefined limits are between about 20% and about 40%.

In operation, the vehicle 10 moves through the exterior air 42 during travel. Movement of the vehicle 10 creates the different pressure zones around the vehicle exterior 12. In particular, the front pressure zone 16 is created which is a zone of relatively high dynamic pressure. In addition, the rear pressure zone 18 is created which is a zone of relatively low dynamic pressure. Since the source port 38 of the inlet duct 26 and the exhaust port 46 of the outlet duct 28 are collocated in a zone of substantially equivalent dynamic pressure, there is minimal passive air flowing through the ventilation system 24. Interior air 48 is recirculated within the cabin interior 14 for air conditioning purposes. The CO₂ sensor and/or the humidity sensor 32 continuously measure the CO₂ and humidity levels within the cabin interior 14. Provided those levels are within the aforementioned predefined limits, as determined by the control module 36, the control module 36 causes no motion of the fan 50.

Since the cabin interior 14 is substantially hermetically sealed from the vehicle exterior 12, CO₂ and humidity levels progressively increase over time as a result of the vehicle 10 being occupied by passengers. When these levels rise above the aforementioned predefined limits, the control module 36 configures the motor 52 to command the fan 50 to rotate at a particular rotational speed in order to provide flow of air from the vehicle exterior 12 to the vehicle interior 14. The flow of air provided by the fan 50 is proportional to the speed of rotation of the fan, thus as the control module 36 commands a change in the speed of the motor 52, the control module 36 controls the air flow into the interior 14 of the vehicle. The control module 36 may be arranged to command a sudden and significant change in the speed of the motor 52, for example a step-change from 20% to 80% fan speed, in order to effect a rapid adjustment to the environment of the vehicle cabin interior 14 at the expense of electrical load from the motor 52 and noise from the fan 50. This may be particularly useful if one or more environmental parameters of the vehicle interior 14 is/are significantly outside of predetermined limits. Additionally or alternatively, the control module 36 may adopt an approach to gradually adjust the fan speed, for example a more linear ramp-up or ramp-down, if one or more environmental parameters of the vehicle interior 14 is/are only slightly outside of predetermined limits, or if energy consumed by the fan motor 52 has a higher priority and/or if the vehicle occupants are particularly sensitive to the noise the motor 52 generates when operating at higher speeds.

Exterior air 42 flowing into the cabin interior 14 through the inlet duct 26 results in an equivalent volume of interior air 48 being exhausted out through the outlet duct 28 to the vehicle exterior 12. Provided the CO₂ levels are higher within the cabin 14 than at the vehicle exterior 12, CO₂ levels will reduce. The same is true of the humidity levels. When the CO₂ and/or humidity levels revert back to within the predefined limits, as determined by the control module 36, the control module 36 configures the motor 52 to stop rotation of the fan 50.

Some environments, for example some major cities around the World, have relatively high levels of humidity and/or CO₂. The complementary exterior sensor 34 measures the exterior air 42 in order to monitor these parameters. It may be the case that the exterior air 42 has non ideal levels of CO₂ and/or humidity, as well as other pollutants. In this case, transferring exterior air 42 to the cabin interior 12 may be detrimental to the cabin environment and occupant comfort. Accordingly, in such circumstances the control module 36 may be configured to configure the motor 52 to keep the fan 50 stationary. The complementary exterior sensor 34 is thus connected to the control module 36 such that the control module 36 may configure the fan 50 to induce an air flow through the ventilation system 24 taking into account both the CO₂ and/or humidity levels within the cabin interior 14 and the vehicle exterior 12.

In a further embodiment, the interior environment parameter sensor 32 is arranged to monitor an environment parameter within the cabin interior 14. The interior environment parameter sensor 32 can either be a CO₂ sensor, a humidity sensor, or a combination of the two.

The exterior environment parameter sensor 34 comprises a complementary environment parameter sensor and a supplementary environmental parameter sensor.

The complementary environment parameter sensor measures the same environment parameter as the interior environment parameter sensor 32. The complementary environment parameter sensor can thus either be a CO₂ sensor, a humidity sensor, or a combination of the two.

The supplementary environment parameter sensor measures an additional environmental parameter of the air, which is different to that measured by the interior environmental parameter sensor 32, such as carbon monoxide (CO) and/or nitrogen oxide (NOx). The supplementary environment parameter sensor can either be a CO sensor, a NOx sensor or a combination of the two.

The CO sensor is an electrochemical instant detection and response (IDR) sensor. The IDR measures the CO content of the air at the vehicle exterior 42 indirectly by monitoring changes in electrical resistance through an electrochemical solution.

The NOx sensor is a potentiometric sensor, which measures the potential difference between a working electrode and reference electrode. The working electrode's potential depends on the concentration of the NOx in the air of the vehicle exterior 42.

The complementary and supplementary exterior sensors measure the exterior air 42 in order to monitor the environment parameters. It may be the case that the exterior air 42 has non ideal levels of CO₂ and/or humidity, as well as other pollutants. In this case, transferring exterior air 42 to the cabin interior 12 may be detrimental to the cabin environment and occupant comfort. Accordingly, the control module 36 would thus configure the motor 52 to keep the fan 50 stationary. The complementary and supplementary exterior sensors are thus connected to the control module 36 such that the control module 36 can configure the fan 50 to induce an air flow through the ventilation system 24 taking into account the CO₂ and/or humidity levels within the cabin interior 14, as well as the CO₂, humidity, CO and NOx levels at the vehicle exterior 12.

The control module 36 is arranged to configure the fan 50 to induce an air flow between the vehicle exterior 12 and the cabin interior 14 based upon the environment parameter measured within the cabin. In addition, the control module 36 uses the reading from the complementary and supplementary exterior parameter sensors such that the rotational speed of the fan 50 is a function of one environment parameter sensed at the vehicle interior 14 and the vehicle exterior 16, and a second environment parameter that is also sensed at the vehicle exterior 16.

In an alternative arrangement of the above described embodiments, the control system is arranged, when operating in a prescribed mode of operation, to continuously vary the fan speed, in order to maintain a constant environment parameter level of CO₂ to a predefined set point such as, for example, 750 ppm. The prescribed mode of operation may be a default mode, a user-selected mode, or a mode automatically triggered based on user preferences, geographical location or time.

It will be appreciated by a person skilled in the art that the invention could be modified to take many alternative forms to that described herein, without departing from the scope of the appended claims.

1. A ventilation system for a land vehicle, the ventilation system comprising:
an inlet duct for allowing exterior air to enter a cabin of the vehicle, the inlet duct having a source port located at an exterior of the vehicle and the inlet duct also having an exhaust port located within the cabin of the vehicle;
an outlet duct for allowing interior air to exit the cabin of the vehicle, the outlet duct having a source port located within the cabin of the vehicle and the outlet duct also having an exhaust port located at an exterior of the vehicle; and
an air propulsion element arranged to selectively cause an airflow between the cabin interior and the vehicle exterior, wherein the inlet duct and the outlet duct share a common structural interface to divide the inlet duct from the outlet duct, and wherein the inlet duct and outlet duct are arranged one inside the other; and
wherein the source port of the inlet duct and the exhaust port of the outlet duct are collocated in a zone of substantially equivalent dynamic pressure, in-use.

2. (canceled)

3. The ventilation system of claim 1, wherein the common structural interface comprises a heat exchange feature.

4. The ventilation system of claim 3, wherein the heat exchange feature comprises one or more of the following: fins, ribs, pins, dimples and grooves.

5. The ventilation system of claim 1, wherein the inlet duct and the outlet duct comprise concentrically arranged pipes.

6. The ventilation system of claim 1, wherein the inlet duct and the outlet duct are formed as eccentrically arranged pipes.

7. The ventilation system of claim 1, wherein the outlet duct forms an interior pipe and the inlet duct forms an exterior pipe.

8. The ventilation system of claim 1, wherein the air propulsion element comprises a variable speed fan.

9. The ventilation system of claim 1, wherein the inlet and outlet ducts are continuous, door-less, ducts arranged aside from the air propulsion element.

10. The ventilation system of claim 1, further comprising at least one interior environment parameter sensor arranged to monitor an environment parameter within the cabin interior.

11. The ventilation system of claim 10, further comprising a control module arranged to configure the air propulsion element to induce a flow of air between the vehicle exterior and the cabin interior based upon a level of the environment parameter measured within the cabin, wherein the flow of air is being arranged to maintain the level of the environment parameter within the cabin to within a predefined limit.

12. The ventilation system of claim 11, further comprising at least one complimentary exterior environment parameter sensor at the vehicle exterior to monitor the same environment parameter as monitored by the at least one interior environment parameter sensor.

13. The ventilation system of claim 12, wherein the control module is arranged to configure the air propulsion element to induce an air flow between the vehicle exterior and the cabin interior based upon a level of the environment parameter at the exterior of the vehicle.

14. The ventilation system of claim 10, wherein the environment parameter is CO₂.

15. The ventilation system of claim 10, wherein the environment parameter is humidity.

16. A land vehicle defining a vehicle exterior having a plurality of dynamic pressure zones in-use, the vehicle comprising a cabin defining a vehicle interior, and wherein the vehicle comprises the ventilation system of claim 1.

17-18. (canceled)
